(19) United States
(12) Patent Application Publication
(10) Pub. No.: US 2013/0334170 A1
(43) Pub. Date: Dec. 19, 2013

(54) TECHNIQUES FOR PRODUCING THIN FILMS OF SINGLE CRYSTAL DIAMOND

(71) Applicant: The Trustees of Columbia University in the City of New York, New York, NY (US)

(72) Inventors: Dirk R. Englund, New York, NY (US); Richard Osgood, Chappaqua, NY (US); Ophir Gaathon, New York, NY (US)

(21) Appl. No.: 13/973,499

(22) Filed: Aug. 22, 2013

Related U.S. Application Data
(63) Continuation of application No. PCT/US2012/027235, filed on Mar. 1, 2012.
(60) Provisional application No. 61/448,902, filed on Mar. 3, 2011.

(51) Int. Cl. C01B 31/06

(52) U.S. Cl. CPC C01B 31/065
USPC 216/51; 216/41; 156/345.3; 156/345.19

(57) ABSTRACT

Techniques for fabricating thin single crystal diamond films from a diamond structure having a top surface including implanting a dose of ions at a predetermined depth below the top surface to form a damage layer, selectively masking the top surface to expose one or more portions of the diamond structure, vertically etching one or more of the exposed portions to the predetermined depth, and exfoliating the unexposed portion to form at least one thin single crystal diamond film.

### CROSS-REFERENCE TO RELATED APPLICATIONS

The present application is a continuation of International Application Serial No. PCT/US2012/027235, filed Mar. 1, 2012 and published in English as W02012/118944 ON Sep. 7, 2012, which claims priority to U.S. Provisional Application Ser. No. 61/448,902, filed Mar. 3, 2011, the contents of which are hereby incorporated by reference in their entireties.

### STATEMENT REGARDING FEDERALLY SPONSORED RESEARCH OR DEVELOPMENT

This invention was made with government support under grants DRM#-MWN-0806682, awarded by the National Science Foundation, and #HDTRA1-11-16-BRCWMD, awarded by the Defense Threat Reduction Agency. The government has certain rights in the invention.

### BACKGROUND

The presently disclosed subject matter relates to techniques for producing thin films of single crystal diamond.

Diamonds have certain qualities, such as thermal conductivity and optical quality, which render their use in integrated circuits (IC) and other microsystems desirable. Methods of producing single-crystal diamond films by growth methods on common substrates are known.

However, single-crystal thin film diamond produced with growth techniques can suffer from an undesirable density of crystal defect, large grain size, high internal stress, poor integration adhesion, and very rough surfaces. Crystal ion slicing (CIS) is a technique which can be used to fabricate thin films using ion implantation. Generally, ions are implanted into a bulk material to create a damage layer at a controlled depth. Thereafter, wet etching or thermal treatment can be used to slice a thin film from the bulk.

Fabrication of single-crystal diamond thin film using CIS techniques can provide diamond films for a wide variety of applications, such as thermal management in ultra-high speed processors, x-ray and UV sources, optoelectronics, quantum information process, and surface mechanics. Accordingly, there is a need for improved techniques to create high quality single crystal diamond films.

### SUMMARY

Methods and systems for producing thin films of single crystal diamond, and more particularly to methods and systems for producing thin films of single crystal diamond in parallel, are disclosed herein.

According to one aspect of the disclosed subject matter, a method for fabricating at least two thin single crystal diamond films includes implanting a dose of ions at a predetermined depth below the top surface of a diamond structure to form a damage layer therein. The top surface of the diamond structure can be masked to form a predetermined pattern exposing one or more portions of the diamond structure. The exposed portions of the diamond structure can be vertically etched to at least the predetermined depth. The unexposed portions of the diamond structure can be exfoliated thereby forming at least one thin single crystal diamond film.

In one embodiment, the dose of ions can be a dose sufficient to graphitize the damage regions. For example, the dose can be around 1.5×10¹⁷ions/cm². He ions can be implanted at a predetermined depth by control of ion implantation energy. For example, ions can be implanted at a predetermined depth of between 150 nm and 300 nm with ion implantation energy between 140 keV and 300 kEv. In another embodiment, the ions can be implanted at a predetermined depth of 1.5 μm to 8.5 μm. For example, He ions can be implanted at a depth of around 2.4 μm with an ion implantation energy of 1.5 MeV and the damage layer created can be roughly 90 nm thick.

In one embodiment, the mask can be a metallic mask. The metallic mask can be applied in a predetermined pattern. For example, the predetermined pattern can be an array of rectangles. The vertical etching can include the use of inductively coupled plasma. The ICP recipe can be a highly chemical ICP recipe to achieve mask selectivity of over 160:1. The ICP system can be operated at a pressure of 85 mTorr.

The accompanying drawings, which are incorporated and constitute part of this disclosure, illustrate preferred embodiments of the disclosed subject matter and serve to explain the principles of the disclosed subject matter.

### BRIEF DESCRIPTION OF THE DRAWINGS

FIG. 1 is a diagram of an exemplary embodiment of the disclosed subject matter.

FIG. 2 is a diagram of another exemplary embodiment of the disclosed subject matter.

FIG. 3 is a schematic representation of an exemplary embodiment of the disclosed subject matter, illustrating an etching of the damaged layer.

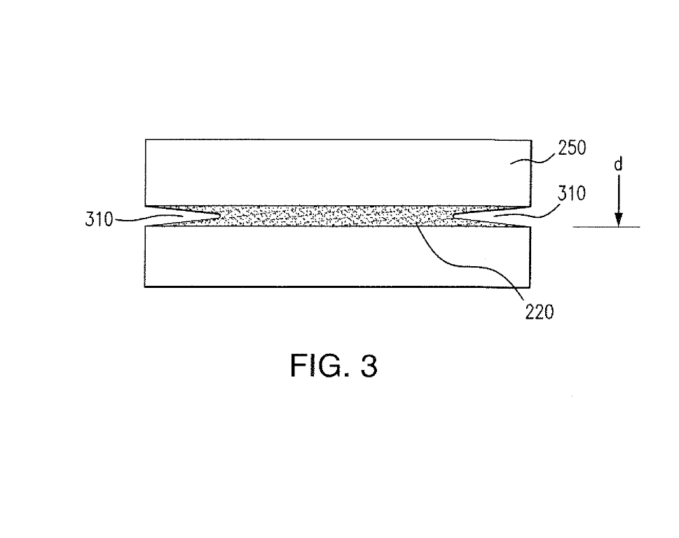

FIG. 4 is a schematic representation of a diamond structure selectively masked in a predetermined pattern according to one embodiment of the disclosed subject matter.

FIG. 5 is an image of patterned single crystal diamond, according to the subject matter disclosed herein, that has been vertically etched but not yet exfoliated.

FIG. 6 is an image of six diamond films, fabricated according to techniques disclosed here, resting on PDMS rubber.

FIG. 7 is a schematic representation of a system for fabrication of diamond films according to an embodiment of the disclosed subject matter.

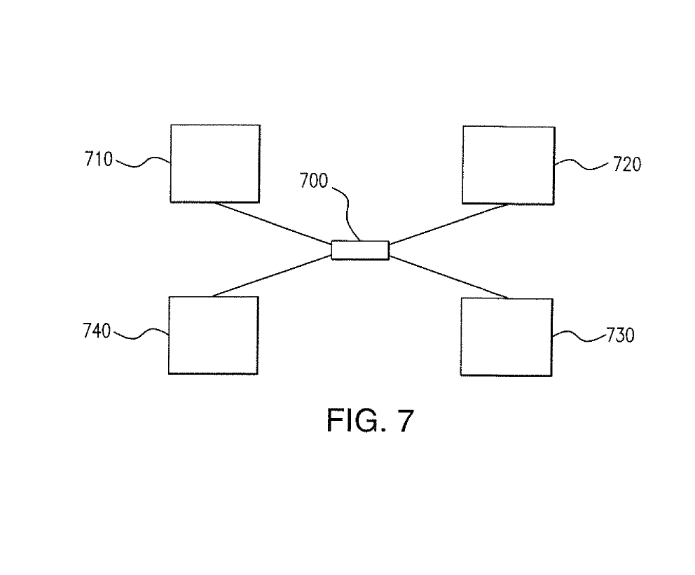

### DETAILED DESCRIPTION

The systems and methods presented herein are generally directed to improved methods and systems for fabrication of thin films of single-crystal diamond in parallel.

In one aspect of the disclosed subject matter, a method for fabricating thin crystal diamond films from a diamond structure having a top surface includes implanting a dose of ions at a predetermined depth below the top surface of the diamond structure to form a damage layer in the diamond structure. The top surface can be masked to form a predetermined pattern exposing one or more portions of the diamond structure. The exposed portions of the diamond structure can then be vertically etched to a predetermined depth. The unexposed portions of the diamond structure are exfoliated to form at least one thin single crystal diamond film.

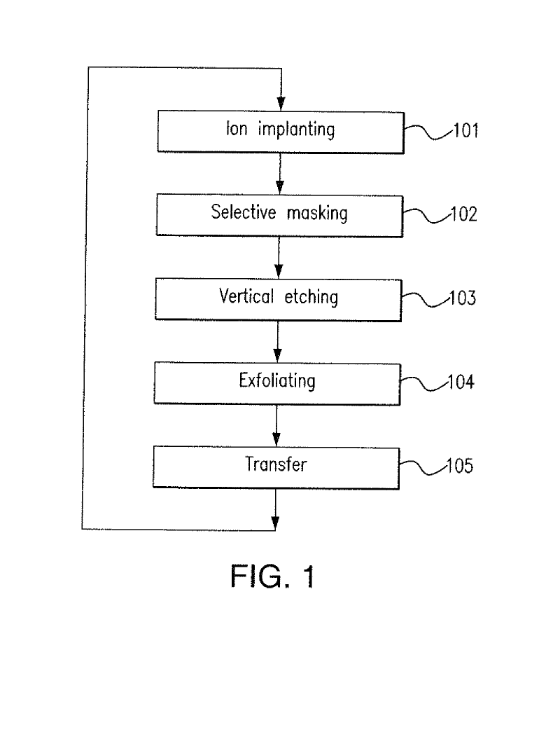

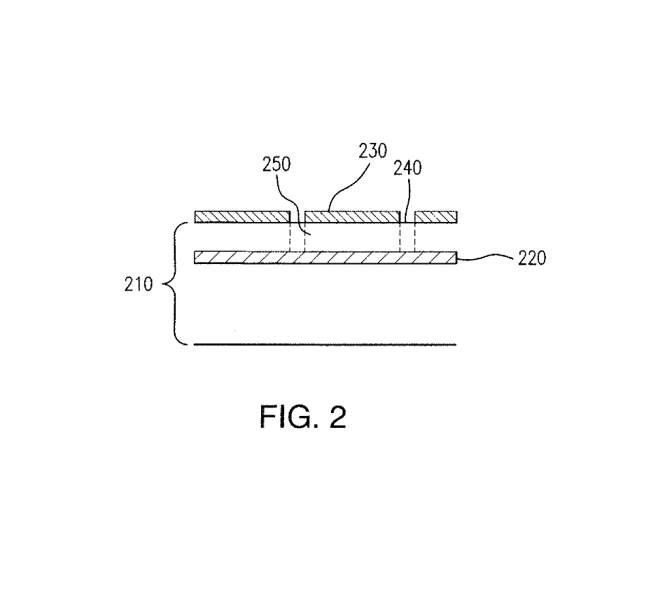

For the purpose of illustration, and not limitation, an exemplary embodiment of the disclosed subject matter is depicted in FIGS. 1 and 2. The diamond structure 210 from which thin diamond films are harvested can be natural or synthetic diamond. It can be synthetic diamond created by high-pressure high-temperature (HPHT) or chemical vapor deposition (CVD) techniques. In an exemplary embodiment, the diamond structure can be type IIa CVD-grown diamond. The top surface can be processed to ensure a high quality surface. For example, the top surface can be mechanically polished, boiled in a corrosive mixture of acids, for example HNO₃, H₂SO₄, and/or NaNO₃, or other suitable techniques to ensure a high quality surface.

Implanting a dose of ions at a predetermined depth below the top surface of the diamond structure (FIG. 1 101) can be accomplished in a manner similar to that of crystal ion slicing (CIS) techniques that have been previously applied to other crystal materials. The ions used for implanting can include, for example, oxygen ions, carbon ions, helium ions, or boron ions.

Damage caused by ion implantation 220 is generally localized at the end of the ion range. The high energy ions cause little damage near the surface of the diamond structure because they lose energy via electronic collisions. At the end of the ion range, the ions can lose more of their energy to nuclear collisions, thus creating a narrow range of damage. Low doses of ions (for example, carbon ions in a dose less than 1.5×10¹⁵ ions/cm² at 100 keV) case damage that is substantially recoverably by thermal annealing. At higher doses, the damaged diamond can be graphitized, i.e., converted into sp² bonds when annealed. At yet higher doses, the diamond can be spontaneously graphitized to such an extent that the damage layer is observable in the visible spectrum.

In some embodiments, ions can be implanted at doses suitable to create a damage layer in the diamond structure which is graphitized when annealed. In other embodiments, ions can be implanted at doses sufficient to graphitize the diamond structure spontaneously. In an exemplary embodiment, helium ions can be implanted at a dose of 1.5×10¹⁷ ions/cm², thereby graphitizing a narrow damage layer, where sp³ bonds convert into the sp² conformation. Ions can be implanted with the use of conventional ion implanters. For example, ions can be implanted using a Dynamitron ion implanter, which can be used to implant He ions.

Ions can be implanted at a predetermined depth by controlling the ion implantation energy. The straggle can be attenuated by more precisely controlling the ion implantation energy. The ion implantation energy required to implant ions at a predetermined depth can be computed with the use of known models. For example, the Stopping and Range of Ions in Matter simulation package, provided by J. F. Zeigler and available at www.srim.org, allows for such a calculation. In generally, required ion implantation energy is positively correlated with ion implantation depth.

Additionally, in some embodiments, a wider damage layer can be created by distributing the dose of implanted ions over a plurality of partially overlapping implantation depths. Creation of a wider damage layer can provide a wider etching gap and accelerate the liftoff process.

In an exemplary embodiment, to fabricate films that are between 150 nm and 300 nm tick, helium ions can be implanted at energies between 140 keV and 300 keV, respectively. The HE ions are implanted at a dose sufficient to graphitize the diamond structure at their implanted depth, thereby creating a damage layer, also referred to as a sacrificial layer. In another embodiment, ions can be implanted at a depth deeper than the desired thickness of the resulting thin film to allow for post-processing that removes a portion of the exfoliated film. For example, in another exemplary embodiment, to obtain films thick enough for manipulation, the ions can be implanted in an energy range to create a graphitized region of roughly 100 nm that is 1.5 μm to 8.5 μm beneath the surface of the diamond structure. In one embodiment, ions with an energy of 1.5 MeV can be implanted to create a damage layer roughly 90 nm thick at a depth of 2.4 μm below the surface.

The top surface of the diamond structure can be selectively masked (FIG. 1, 102) to form a predetermined pattern exposing one or more portions of the diamond structure. In an exemplary embodiment, the mask 230 is a metallic mask. It can be formed from, for example Cr, Al, or Ti. The mask can be defined using either lift-off or etch techniques.

The purpose of the mask is to selectively expose portions of the diamond structure 240 for vertical etching using, for example, inductively coupled plasma (ICP). By vertically etching the exposed portions 240 of the diamond structure to a depth of at least the damage layer, access is provided to the graphitized layer 220 for either wet etching or annealing in the presence of oxygen. Thus, one of ordinary skill in the art will recognize that different materials and techniques can be suitable for selectively masking the top surface of the diamond structure. For example, the thickness of the mask should be thick enough to withstand application of ICP for at least the time it takes to vertically etch to a depth of the damage layer.

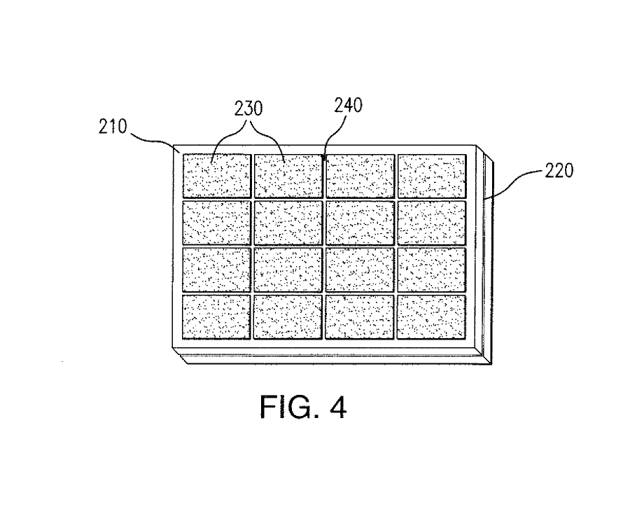

The mask can define a predetermined pattern which informs the shape of the resulting thin film diamond. For example, and with reference to FIG. 4, in an exemplary embodiment, the mask 230 defines an array of rectangles, each rectangle covered by the mask with the exposed portion 240 being the space between the rectangles. The rectangles can have dimensions of, for example, 120 nm by 120 nm. Different patterns can be selected for desired resulting shapes.

After top surface of the diamond structure is selectively masked, the exposed portion of the diamond structure 240 are vertically etched (FIG. 1, 103). Vertical etching both exposes the damage layer 220 for subsequent exfoliation and defines the sidewalls of the resulting thin film diamonds. One of ordinary skill in the art will recognize that a variety of methods are suitable to vertically etch the exposed portion of the diamond structure.

In an exemplary embodiment, vertical etching is done using inductively coupled plasma (ICP). A suitable ICP recipe can be designed, taking into considerations such as the thickness and composition of masking material. For example, to achieve mask selectivity of over 160:1, a highly chemical ICP recipe can be designed. In an exemplary embodiment, a highly chemical recipe can include the following characteristics: the amount of O₂ can be 30 sccm (standard cubit centimeter per minute), the pressure can be 85 mTorr, the ICP forward power can be 60 w, the RF generator power can be 150 w, and the temperature can be 10° C. The mask can be a 60 nm Cr mask for greater than a 10 sccm etch depth prior to degradation of the mask. The pattern of the mask can define trapezoidal-footprint films that are asymmetric under a vertical flip to allow identification of the front and back surface orientation under an optical microscope.

The ICP system can be operated at 85 mTorr. This pressure can reduce ion bombardment by reducing the ion mean free path and can correspond to isotopic chemical etching. The use of ICP to vertically etch the diamond structure can allow for scalability and massively parallel fabrication of diamond thin films. Conventional milling techniques, such as focused ion beam (FIB) techniques using argon or gallium typically do not allow for such parallel fabrication.

In other embodiments, where the damage layer is closer to the surface, for example, less than 1 μm from the surface, a highly kinetic ICP process can be applied. In one embodiment, this highly kinetic ICP process can include the following characteristics: the amount of O₂ can be 70 sccm, the amount of Ar can be 10 sccm, the pressure can be 15 mTorr, the ICP forward power can be 500 w, the RF generator power can be 450 w, and the temperature can be 10° C. In yet other embodiments, different etching processes, suitable to vertically etch the diamond structure to the damage layer in parallel, can be applied. In another embodiment, the ICP recipe can include the following characteristics: the amount of O₂ can be 30 sccm, the pressure can be 85 mTorr, the ICP forward power can be 60 w, the RF generator power can be 150 w, and the temperature can be 10° C. Upon completion of the vertical etching, the remaining mask can be removed using conventional techniques.

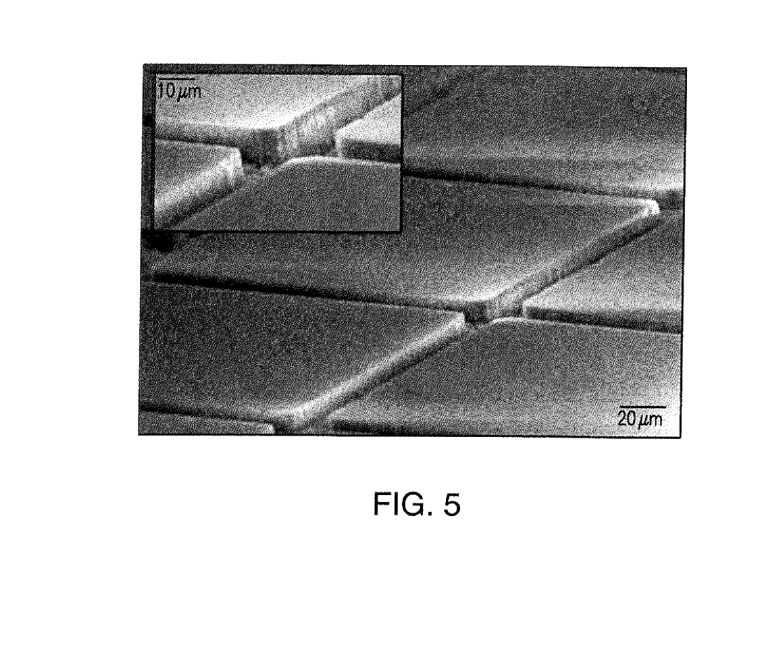

FIG. 5 depicts a scanning electron microscope (SEM) image of patterned single crystal diamond, according to the subject matter disclosed herein, that has been vertically etched but not yet exfoliated.

After the vertical etching is completed and the damage layer 220 is exposed, the unexposed portions of the diamond structure 250 are exfoliated (FIG. 1, 104), thus forming at least one thin single crystal diamond film. Exfoliation can include annealing, wet etching, or a combination of both.

For example, where the ion implantation dose was insufficient to spontaneously graphitize the damage layer, annealing can be preformed at temperatures sufficient to graphitize the damage layer. The temperature could be, for example, around 550° C. Annealing can take place in the presence of air. In this example, annealing has an additional benefit of partially restoring regions of the diamond structure, other than the damage layer, that have been incidentally damaged. The annealing can take place, for example, over the period of an hour.

In another example, where the ion implantation has graphitized the damage layer, annealing at temperatures between 550° C. and 585° C. in the presence of oxygen can oxidize the graphite. At temperatures above 585° C., single-crystal diamond will also react with oxygen. Thus, by annealing at a temperature between 550° C. and 585° C. in the presence of oxygen, the graphitize damage layer can be selectively etched without effecting other portions of the diamond structure.

In yet another example, exfoliation can be accomplished with a wet etching technique. In an exemplary embodiment, the diamond structure first undergoes a high temperature annealing in an oxygen free environment. The temperature can be, for example, 850° C. This annealing can condition the damage layer for more efficient exfoliation and also cure surface defects that occur due to, for example, ICP etching. Strong chemically active agents, for example a cocktail of three acids, perchloric, nitric, and sulphuric acid in a concentration of 1:1:1: can be introduced to the damage layer. This process can be enhanced at elevated temperatures, for example at around 220-300° C., which is roughly around the boiling point of some of the acids. The acids will selectively etch the graphitized layer, but due to the chemical stability of the surrounding single-crystal diamond, the single-crystal diamond will remain in tact.

The examples just discussed are illustrative, and one of ordinary skill in the art will appreciate that various other methods can be suitable to exfoliate the unexposed portions of the diamond structure to form the thin single-crystal diamond films. For example, additional techniques can include polarizing the graphitized damage layer and exposing it to distilled water containing electrolytes.

After the unexposed portions of the diamond structure have been exfoliated, thereby defining the thin single-crystal diamond films, the diamond films can then be transferred off of the underlying diamond structure (FIG. 1, 105). For example, the diamond films can be transferred on to a wafer revealing their back side (i.e., the side that was adjacent to the damage layer). In one embodiment, a PDMS stamping technique can be used to transfer the films. The PDMS can be made sticky so as to pick up the films and transfer them to a substrate. In other embodiments, alternative transfer techniques can be used. For example, a bisbenzocyclobutene (BCB) layer can be used as the adhesive for permanent lamination. In another embodiment, the exfoliated films can be removed from the etching solution and transferred onto a sapphire wafer. The sapphire wafer can allow for subsequent processing and characterization due to its optical and thermal properties.

The thin single-crystal diamond films can then be further processed to remove defects or generate desired characteristics. For example, the films can be further annealed to ensure that any residual damage is removed. Additionally, further wet etching techniques can be used to ensure that damage is removed and the surfaces of the film are of high quality. Moreover, further annealing and wet etching can thin down the films to meet desired design specifications. Alternatively, the films can be thickened by growing homoepitaxial diamond on the surface of the film at any point after the ions have been implanted.

In an exemplary embodiment, where the diamond structure had been implanted with He ions, the bottom side of the exfoliated films can contain He-induced centers from residual ion implantation damage. These centers can cause light absorption, which can not be desired. This opaque layer can be removed using sequential dry etching and annealing cycles. As noted above, the thickness of the exfoliated film, and the depth of the ion implantation, can be predetermined to account for subsequent processing that removes a portion of the bottom of the film.

The dry etching in this post-processing procedure can be an ICP technique. The annealing can include two different procedures. First, the films can be annealed at roughly 500° C. in the presence of oxygen. This can burn off the defects on the bottom layer of the films. The films can then be annealed at high temperatures in low vacuum, and also in a forming gas. Annealing in a forming gas can allow present hydrogen to bond to the oxygen, such that no oxygen reaches the surface of the films. The dry etching and annealing cycles can result in roughly half of the film being removed.

Additional post-processing can also be performed. For example, in one embodiment, nitrogen impurities can be converted to negatively charged NV centers by performing several annealing schedules. First, a low-vacuum (˜1 Ton) annealing procedure at a temperature of roughly 1000° C. is conducted. This can induce a mild graphitization in the surface of the films. The films can then be annealed for several hours in forming gas at 1100° C., which can remove the graphitized surface. These procedures can smooth the film surface and remove contamination, if any, introduced during ICP etching. A third mid-temperature annealing procedure, at a temperature of 520° C., can be performed to convert the charge state of the NV centers from neutral to negatively charged.

After the single-crystal diamond films have been exfoliated, the process can be repeated on the underlying diamond structure, thereby allow for efficient use of diamond and allowing for cost effective and efficient parallel production of thin single-crystal diamond films.

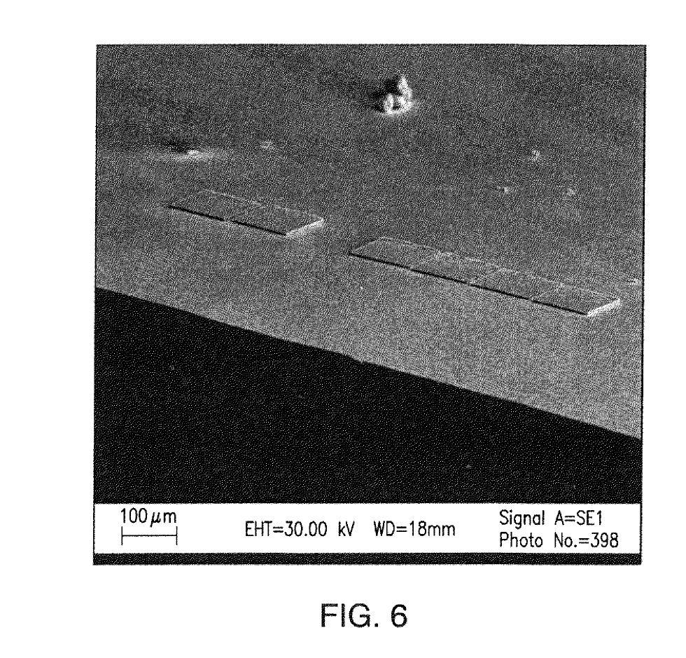

FIG. 6 depicts a scanning electronic microscope (SEM) image of six diamond films, fabricated according to techniques disclosed here, resting on PDMS rubber. Each film is 120 μm on its side and 5 μm thick. The trenches visible in the image were created by dry-etching techniques and expose the graphitized damage layer and enable accelerated exfoliation with predetermined film shape (here, rectangular).

In another aspect of the presently disclosed subject matter, a system for fabricating at least two thin single crystal diamond films from a diamond structure having a top surface includes an ion implantation device, a masking device, an etching device, and an exfoliating device.

In one embodiment, the system can fabricate at least two thin single crystal diamond films from a diamond structure 700 having a top surface. The system can include an ion-implantation device 710 operatively coupled to the diamond structure. The ion-implantation device 700 can be, for example, a Dynamitron ion implanter. The ion implantation device can implant a dose of ions at a predetermined depth below the top surface of the diamond structure 700 to form a damage layer.

The system can include a masking device 720 operatively coupled to the diamond structure 700 for selectively applying a mask to the top surface of the diamond structure 700 to form a predetermined pattern exposing one or more portions of the diamond structure. The masking device can be capable of applying a metallic mask, for example a metallic mask of Cr, at desired thickness.

The system can include an etching device 730 operatively coupled to the diamond structure 700 for vertically etching one or more of the exposed portions of the diamond structure 700 to at least the predetermined depth at which the ions were implanted. The etching device 730 can be, for example, an inductively coupled plasma etching device.

The system can include an exfoliating device 740 operatively coupled to the diamond structure 700 for exfoliating unexposed portions of the diamond structure to thereby form at least one thin single crystal diamond film. The exfoliating device 740 can include, for example, an annealing oven. The exfoliating device 740 can include, for example, a chamber for wet etching. The exfoliating device 740 can be a combination of a chamber for wet etching and an annealing oven.

In another aspect of the presently disclosed subject matter, single-crystal diamond nanoparticles can be fabricated according to the methods and systems described above, where certain defects can be selected or introduced into the diamond nanoparticles either before or after exfoliation from a diamond structure.

Atomic defects in diamond crystal present excellent light sources and sensors for biological and physical sciences. For example, non-bleaching, ultra bright, fluorescent biomarkers with different colors; nanoparticles with single photon emission for quantum information processing;

improved electron-spin based magnetic sensors with ultra-long coherent time; nanoscale sensors for electric fields an strain; nanoparticles for optical tweezers with a large dielectric constant. One defect in diamond is the Nitrogen-Vacancy (NV) center because it can possess additional electron and nuclear spin degrees of freedom with a long coherence time that can act as a quantum memory for long distance quantum communications, quantum computing, and nanoscale magnetometry.

Nanoparticles produced by conventional CVD and detonation techniques can result in a high density of non-carbon contamination. In addition, the shape of the particles is not controllable. Nanoparticles produced according to the subject matter disclosed herein can provide high-purity diamond nanoparticles with deterministic shapes and sizes.

Although the disclosed subject matter has been described in connection with particular embodiments thereof, it is to be understood that such embodiments are susceptible of modification and variation without departing from the disclosure. Such modifications and variations, therefore, are intended to be included within the spirit and scope of the appended claims.

1. A method for fabricating at least two thin single crystal diamond films from a diamond structure having a top surface, comprising:
implanting a dose of ions at a predetermined depth below the top surface of the diamond structure to form at least a partial damage layer therein;
selectively masking the top surface of the diamond structure to form a predetermined pattern exposing one or more portions of the diamond structure;
vertically etching one or more of the exposed portions of the diamond structure to at least the predetermined depth; and
exfoliating unexposed portions of the diamond structure to thereby form at least two thin single crystal diamond films.

2. The method of claim 1, wherein the implanting further comprises crystal ion slicing.

3. The method of claim 2, further comprising determining the predetermined depth by control of ion implantation energy.

4. The method of claim 1, wherein the dose of ions is approximately 10¹⁷ ions/cm².

5. The method of claim 3, wherein the predetermined depth comprises a depth between 150 nm and 300 nm.

6. The method of claim 5, wherein the ion implantation energy comprises an energy between 140 keV and 300 keV.

7. The method of claim 3, wherein the predetermined depth comprises a depth between 1.5 μm and 8.5 μm.

8. The method of claim 7, wherein the predetermined depth further comprises a depth of 2.4 μm.

9. The method of claim 8, wherein the ion implantation energy is 1.5 MeV.

10. The method of claim 3, wherein the predetermined depth comprises a depth between 150 μm and 8.5 μm.

11. The method of claim 3, wherein the predetermined depth comprises a depth between 300 nm and 1.5 μm.

12. The method of claim 1, wherein the masking further comprises masking through a metallic mask.

13. The method of claim 12, wherein the masking further comprises masking through a mask formed from one or more of Cr, Al, Ti.

14. The method of claim 1, wherein the vertically etching further comprises etching using a technique selected from the group consisting of inductively coupled plasma etching, and. reactive ion etching

15. The method of claim 1, wherein the vertical etching further comprises etching at least the depth of the predetermined depth of the implanted ions.

16. The method of claim 1, wherein the exfoliating further comprises forming a thin single crystal diamond film that has a thickness of approximately 5 μm and a width of 120 μm.

17. The method of claim 1, further comprising:
repeating implanting, masking, etching, and exfoliating to thereby perform layer by layer removal of exfoliated thin single crystal diamond film.

18. A system for fabricating at least two thin single crystal diamond films from a diamond structure having a top surface, comprising:
an ion-implantation device, operatively coupled to the diamond structure, for implanting a dose of ions at a predetermined depth below the top surface of the diamond structure to form at least a partial damage layer therein;
a masking device, operatively coupled to the diamond structure, for selectively applying a mask to the top surface of the diamond structure to form a predetermined pattern exposing one or more portions of the diamond structure;
an etching device, operatively coupled to the diamond structure, for vertically etching one or more of the exposed portions of the diamond structure to at least the predetermined depth; and
an exfoliating device, operatively coupled to the diamond structure, for exfoliating unexposed portions of the diamond structure to thereby form at least two thin single crystal diamond films.

19. The system of claim 18, wherein the mask comprises a metallic mask.

20. The system of claim 18, wherein the mask comprises a mask formed from one or more of Cr, Al, Ti.

21. The system of claim 18, wherein the exfoliating device further comprises an annealing oven.

22. The system of claim 18, wherein the exfoliating device further comprises a chamber for wet etching.
